(19) United States
(12) Patent Application Publication
(10) Pub. No.: US 2003/0226769 A1
(43) Pub. Date: Dec. 11, 2003

(54) Kit for assaying saccharified protein

(76) Inventor: Koji Sode, Tokyo (JP)

Correspondence Address: BIRCH STEWART KOLASCH & BIRCH, PO BOX 747, FALLS CHURCH, VA, 22040-0747, US

(21) Appl. No.: 10/296,323

(22) PCT Filed: May 23, 2001
(86) PCT No.: PCT/JP01/04315

(51) Int. Cl. G01N 27/26

(52) U.S. Cl. 205/777.5; 204/403.14

(57) ABSTRACT

A novel method of assaying glycated hemoglobin, glycated albumin or a fructosamine which is a degradation product thereof are disclosed. In particular, the present invention provides a method for assaying fructosamine which comprises oxidizing fructosamine by using a compound having an imidazole group as a catalyst in the presence of an appropriate mediator (an electron acceptor), and measuring the reduced form of the mediator.

### TECHNICAL FIELD

The present invention relates to a novel method for assaying glycated proteins. More specifically, it relates to a method for assaying glycated hemoglobin (HbA1c), glycated albumin, and fructosyl-valine or fructosamine which is a degradation product of these proteins, as well as an assay reagent and a sensor for use in the method. The method of the invention my be used in the field of, for example, clinical laboratory tests.

### BACKGROUND ART

Amino groups in the backbone and side chains of a protein can be non-enzymatically bound to a reducing end-group of a reducing sugar, such as glucose, to form an amadori compound, i.e. a glycated protein. In the blood, hemoglobin is glycated to form glycated hemoglobin (glycohemoglobin; HbA1c). The ratio of HbA1c to hemoglobin in patients with diabetes mellitus is higher than that in healthy persons, and the blood level of HbA1c reflects a blood glucose level over a period of past several weeks. Thus, the blood level of HbA1c is very important in diagnosis of diabetes mellitus and as an indicator of blood glucose level control in patients suffering from diabetes mellitus. In addition to glycated hemoglobin, glycated albumin also serves as an indicator for determining the past blood glucose levels. Both glycated albumin and glycated hemoglobin have been used for diagnosis of diabetes mellitus. The following chemical formula shows a reaction in which valine at the N-terminus of beta-globin in hemoglobin is bound to glucose to form fructosyl-valine, an amadori compound.

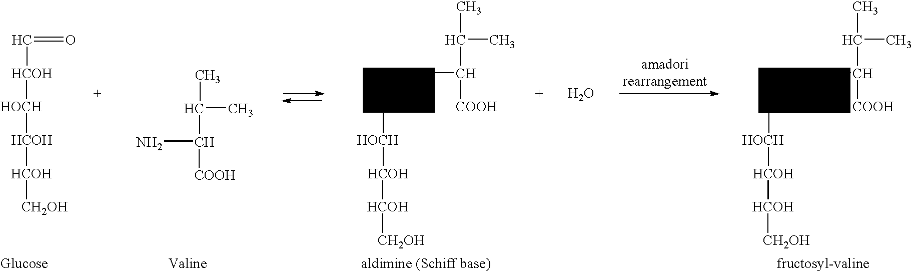

Fructosamine oxidases that act upon amadori compounds have been isolated from various species. It has been suggested that glycated albumin, HbA1c, and other glycated proteins and fructosamines can be assayed by the use of fructosamine oxidase (Japanese Patent Public Disclosure No. 61-268178, No. 61-280297, No. 03-155780, No. 05-192193, No. 07-289253, and No. 08-154672; Agric. Biol. Chem., 53(1), 103-110,1989; Agric. Biol. Chem., 55(2), 333-338,1991; J. Biol. Chem., 269(44), 27297-27302, 1994; Appl. Environ. Microbiol., 61(12), 4487-4489, 1995; Biosci. Biotech. Biochem., 59(3), 487-491, 1995; J. Biol. Chem., 270(1), 218-224, 1995; J. Biol. Chem., 271(51), 32803-32809,1996; J. Biol. Chem., 272(6), 3437-3443,1997).

It would be desirable to improve the stability of fructosamine oxidases and provide a novel catalyst capable of catalyzing oxidation of fructosamines. It is also desirable to provide a method for assaying glycated hemoglobin (HbA1c), glycated albumin and other glycated proteins by measuring fructosamines, as well as assay reagents and sensors for use in clinical laboratory tests.

### DISCLOSURE OF INVENTION

It has now been found that glycated proteins can be assayed by reacting fructosamines with a compound containing imidazole.

The present invention provides a method for assaying fructosamine. The method comprises oxidizing fructosamine in the presence of an appropriate mediator (electron acceptor) and an imidazole containing compound as a catalyst, and measuring the amount of the reduced mediator. In particular, the present invention provides a method for assaying fructosamine, wherein the assay is performed in the presence of a mediator in a reaction solution of pH 6-10.

The present invention further provides a method for assaying fructosamine in a sample. The method comprises the steps of:

1) reacting the sample in a reaction solution at pH 6-10 with an imidazole containing compound in the presence of a mediator;

2) measuring the amount of a reduced mediator formed by the reaction; and

3) determining the concentration of the fructosamine in the sample based on a calibration curve prepared by using standard fructosamine solutions.

The present invention also provides a method for assaying a glycated protein in a sample. The method comprises the steps of:

1) enzymatically or chemically degrading the glycated protein in the sample to form fructosamine;

2) reacting the sample in a reaction solution at pH 6-10 with an imidazole containing compound in the presence of a mediator;

3) measuring the amount of a reduced mediator formed by the reaction;

4) determining the concentration of the fructosamine based on a calibration curve prepared by using standard fructosamine solutions; and

5) determining the amount of the glycated protein in the sample based on the concentration of the fructosamine.

In addition, the present invention provides a fructosamine assay kit comprising an imidazole containing compound. The kit may optionally comprise at least one selected from a buffer solution, a mediator, a standard solution of a fructosamine or its derivative for the preparation of a calibration curve, and a direction for use.

The present invention further provides a sensor for fructosamine assay, comprising a working electrode on which an imidazole containing compound is immobilized, a counter electrode, and a reference electrode in a buffer solution.

The present invention also provides a glycated hemoglobin assay kit comprising an imidazole containing compound. The kit may optionally comprise at least one selected from a hydrolytic reagent or proteolytic enzyme capable of acting on glycated hemoglobin, a buffer solution, a mediator, a standard solution of fructosyl-valine or its derivative for the preparation of a calibration curve, and a direction for use.

The present invention further provides a sensor for glycated hemoglobin assay, comprising a working electrode on which an imidazole containing compound is immobilized, a counter electrode, and a reference electrode in a buffer solution.

The present invention also provides a glycated albumin assay kit comprising an imidazole containing compound. The kit may optionally comprise at least one selected from a hydrolytic reagent or proteolytic enzyme capable of acting on glycated albumin, a buffer solution, a mediator, a standard solution of fructosyl-ε-lysine or its derivative for the preparation of a calibration curve, and a direction for use.

In addition, the present invention provides a sensor for glycated albumin assay, comprising a working electrode on which an imidazole containing compound is immobilized, a counter electrode, and a reference electrode in a buffer solution.

In another aspect, the present invention provides a method for diagnosis of diabetes mellitus. The method comprises the step of measuring fructosamine or a glycated protein in a sample from a subject using the method of the present invention.

### BRIEF DESCRIPTION OF THE DRAWINGS

FIG. 1 shows a result of measuring the concentration of fructosyl-valine based on a discoloring rate of dichlorophenolindophenol (DCIP) in a buffer (pH 7.0) using a carbon paste electrode comprising polyvinylimidazole, and 1-methoxyphenazine methosulfate (m-PMS) and DCIP as mediators.

FIG. 2 shows a result of oxidation of fructosyl-valine in a solution containing 10 mM fructosyl-valine and different concentrations of 1-vinylimidazole in the presence of PMS and DCIP.

FIG. 3 is a response of a fructosamine sensor comprising the polymer prepared in Example 1 in different concentrations of fructosyl-valine.

FIG. 4 shows a response of the fructosamine sensor comprising the polymer prepared in Example 1 in different concentrations of fructosyl-valine.

FIG. 5 shows a response of the fructosamine sensor comprising the polymer prepared in Example 3 in different concentrations of fructosyl-valine.

### DETAILED DESCRIPTION OF THE INVENTION

The term “a glycated protein” as used herein means a compound formed by non-enzymatic binding of an amino group in a backbone or side chains of a protein to a reducing end-group of a reducing sugar, such as glucose. Typical glycated proteins include glycated hemoglobin and glycated albumin.

The term “fructosamine” as used herein means an amadori compound formed through amadori rearrangement of a Schiff base type aldimine, which is formed by a reaction between an amino acid and glucose. Examples of fructosamine include, but are not limited to, fructosyl-valine, fructosyl-ε-lysine, fructosyl-glycine, fructosyl-alanine, and fructosyl-phenylalanine.

Assay Methods

In on aspect, the present invention provides a method for assaying fructosamine, which comprises oxidizing fructosamine in the presence of an appropriate mediator (electron acceptor) and an imidazole containing compound as a catalyst, and measuring the amount of the reduced mediator thus formed.

In the present invention, a glycated protein such as glycated albumin or HbA1c, or a fructosamine such as fructosyl-valine formed by enzymatic or chemical degradation of glycated albumin or HbA1c can be assayed by reacting the fructosamine or the like with a compound containing imidazole. Preferably, the reaction is performed in the presence of a mediator in a reaction solution of pH 6 to 10, preferably pH 6 to 8, more preferably pH 6.5 to 7.5, and most preferably around pH 7.

Glycated hemoglobin or glycated albumin can be degraded into a fructosamine either enzymatically by a proteolytic enzyme or chemically by acid hydrolysis. Examples of the proteolytic enzyme include commercially available proteinase K, trypsin, and aminopeptidase. The reaction conditions may be pursuant to those generally used for these enzymes. For acid hydrolysis, hydrochloric acid can be employed. Glycated hemoglobin is degraded into fructosyl-valine, and glycated albumin is degraded into glycated lysine, i.e., fructosyl-E-lysine.

One aspect of the present invention provides a method for assaying fructosamine. The method comprises the steps of:

1) reacting a sample in a reaction solution at pH 6-10 with an imidazole containing compound in the presence of a mediator;

2) measuring the amount of a reduced mediator formed by the reaction; and

3) determining the concentration of the fructosamine in the sample based on a calibration curve prepared by using standard fructosamine solutions.

In another aspect, the present invention provides a method for assaying a glycated protein. The method comprises the steps of:

1) enzymatically or chemically degrading the glycated protein in the sample to form fructosamine;

2) reacting the sample in a reaction solution at pH 6-10 with an imidazole containing compound in the presence of a mediator;

3) measuring the amount of a reduced mediator formed by the reaction;

4) determining the concentration of the fructosamine based on a calibration curve prepared by using standard fructosamine solutions; and

5) determining the amount of the glycated protein in the sample based on the concentration of the fructosamine.

The imidazole-containing compound can serve as a catalyst in this assay. Any compounds capable of oxidizing fructosamine to generate a reduced form of an electron acceptor (mediator) can be used as an imidazole-containing compound. Such an imidazole-containing compound for used in the assay of fructosamines may be a monomer or a polymer of a compound containing one or more imidazole groups. Examples of the monomer include imidazole compounds such as 2-methylimidazole, 4-methylimidazole, N-acetylhistidine, imidazole, 2-methyl-4-hydroxyl-6-aminobenzimidazole, 4-(2′,4′-dihydroxyphenyl)imidazole, 4-hydroxymethyli midazole, carbobenzoxy-L-histidyl-L-tyrosine ethyl ester, 2-methylbenzimidazole, histamine, 6-aminobenzimidazole, 4-hydroxy-6-aminobenzimidazole, benzimidazole, 4-hydroxybenzimidazole, histidine methyl ester, 2-methyl-4-hydroxy-6-nitrobenzimidazole, 4-methoxybenzimidazole, 4-bromoimidazole, 6-nitrobenzimidazole, 4-hydroxy-6-nitrobenzimidazole, 4-nitroimidazole, viniylimidazole, as well as heterocyclic compounds analogous to imidazole, such as pyridine, 4-picoline, pyrrole, 3,5-dimethylpyrazole, 1,2,4-triazole, indole, benzotriazole. Preferred are vinylimidazoles, particularly 1-vinylimidazole and 4,5-divinylimidazole. Examples of the polymer of the imidazole-containing compounds include imidazole-containing polymers obtained by polymerizing imidazole-containing monomers. Preferred are polyvinylimidazole polymers obtained by polymerizing vinylimidazoles. Copolymers comprising at least one imidazole-containing compound as a component can also be used.

The polyvinylimidazole can be prepared by any processes or conditions known to those skilled in the art. For example, polyvinylimidazole can be prepared by radical polymerization using a polymerization initiator. Examples of a polymerization initiator include peroxides such as benzoyl peroxide, di-t-butyl peroxide, potassium persulfate; azo initiators such as azobisisobutyronitrile (AIBN), methyl azobisisobutyrate, azobiscyclohexanecarbonitrile, azobisisobutyramidine hydrochloride, 4,4′-azobis-4-cyanovaleric acid, and 2,2-azobis(2,4-dimethylvaleronitrile); and redox-type initiators. Alternatively, the polyvinylimidazole can be prepared by photoradical polymerization using a flavin dye.

The polymer of the imidazole-containing compound may be crosslinked using a crosslinking agent. Examples of a crosslinking agent which can be added upon polymerization of vinyl monomers include, for example, divinyl compounds (e.g., divinylbenzene, 1,5-hexadien-3-yne, hexatriene, divinyl ether, and divinyl sulfone), and diallyl compounds (e.g., allyl phthalate, 2,6-diacrylphenol, diallyl carbinol, and ethylene glycol dimethacrylate (EGDMA)).

According to the assay method of the present invention, the fructosylamine is reacted with the imidazole-containing compound in the presence of a mediator. The reaction is performed in a solution preferably having pH of 6 to 10, more preferably pH of 6 to 8, further preferably pH of 6.5 to 7.5, and most preferably pH of around 7. Examples of a solution include, for example, buffer solutions such as phosphate buffer, citrate buffer, Tris-HCl buffer with the pH being adjusted using NaOH or the like. Preferred is a phosphate buffer.

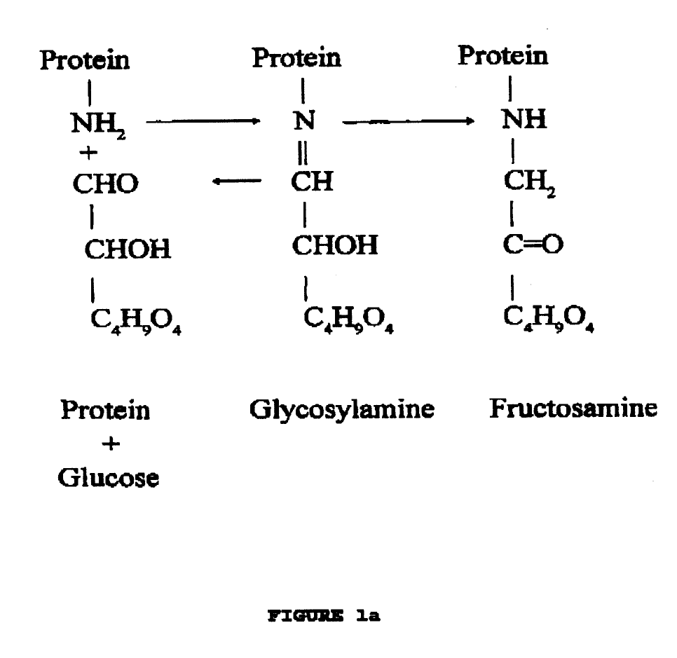

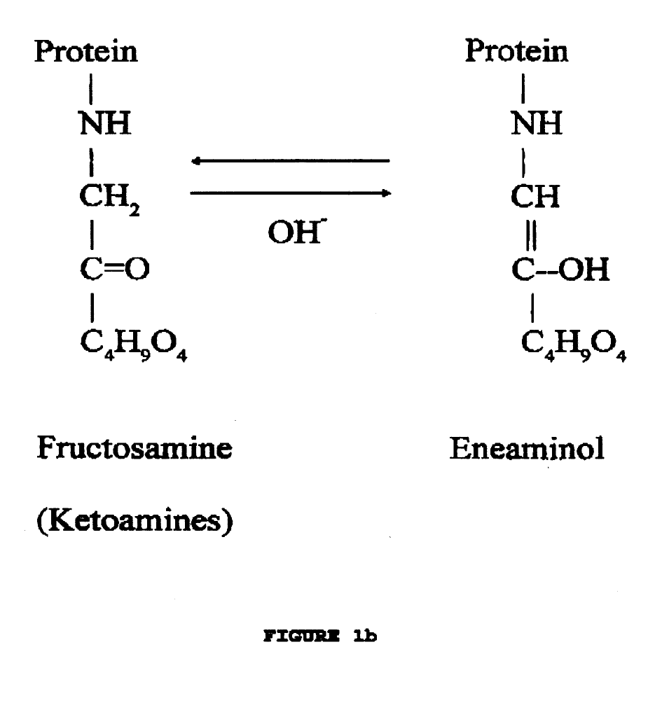

When a reaction is allowed to proceed in the presence of polyvinylimidazole as a catalyst, phenazine methosulfate (PMS) and dichlorophenolindophenol (DCIP) as mediators, and fructosyl-valine as a substrate, fructosyl-valine is oxidized with time, while DCIP is reduced by the mediation of PMS and is discolored. The concentration of fructosyl-valine can be determined based on the rate of discoloring of DCIP as an indicator, as shown in FIG. 1. Fructosyl-valine concentration can be determined with a sensitivity less than or equal to 1 mM by using polyvinylimidazole as a catalyst, and phenazine methosulfate (PMS) and dichlorophenolindophenol (DCIP) as mediators. The assay principle of the present invention using fructosyl-valine is shown as follows.

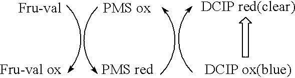

In the assay method of the present invention, various artificial electron mediators can also be used. Examples of such a mediator include potassium ferricyanide, ferrocene, and osmium derivatives. The mediator may be impregnated into a polymer. Also the mediator may be added to and mixed with the polymer upon the polymerization reaction. In addition, copolymers containing these mediators, for example, a copolymer of vinylferrocene and vinylimidazole, can be prepared and used in the method of the present invention.

Assay Kits

In another aspect, the present invention provides a kit for assaying fructosamine. The fructosamine assay kit of the present invention comprises a reaction solution containing the imidazole-containing compound according to the present invention in a sufficient amount for at least one assay. Typically, the assay kit comprises polyvinylimidazole, a buffer solution adjusted to pH of 6.0 to 10, an appropriate mediator, a standard solution of a fructosamine (e.g., fructosyl-valine) or its derivative for the preparation of a calibration curve, and directions for use. The fructosamine assay kit according to the present invention can be supplied in various forms, such as a freeze-dried reagent and in an appropriate preservative solution. A preferred assay kit is a fructosyl-valine assay kit. Another preferred assay kit is a fructosyl-ε-lysine assay kit.

In yet another aspect, the present invention provides a HbA1 c assay kit. HbA1c can be assayed by enzymatically or chemically degrading HbA1c to form fructosyl-peptides and fructosyl-valine, then quantifying the fructosyl-valine using the fructosyl-valine assay kit of the present invention. Thus, the HbA1c assay kit of the present invention further comprises a hydrolyzing reagent or a proteolytic enzyme in addition to the fructosyl-valine assay kit.

In yet another aspect, the present invention provides a glycated albumin assay kit. The glycated albumin can be assayed by enzymatically or chemically degrading glycated albumin to form fructosyl-peptides and fructosyl-E-lysine, then quantifying the fructosyl-ε-lysine using the fructosyl-ε-lysine assay kit of the present invention. Thus, the glycated albumin assay kit of the present invention further comprises a hydrolyzing reagent or a proteolytic enzyme in addition to the fructosyl-ε-lysine assay kit.

The HbA1c assay kit and the glycated albumin assay kit of the present invention are useful for diagnosis of diabetes mellitus.

Sensors

In another aspect, the present invention provides a sensor used for glycated albumin, HbA1c and fructosamine assay. In the assay using the sensor of the present invention, a substrate is oxidized by an imidazole-containing compound whereas a mediator is reduced, which in turn is electrochemically oxidized on the electrode. The concentration of the substrate can be determined from the amount of current. Examples of the electrode used in the sensor include, for example, a carbon electrode, a gold electrode, and a platinum electrode. The imidazole-containing compound for use as a general base catalyst in the present invention may be immobilized on the electrode. The imidazole-containing compound may be immobilized according to any of the known processes, such as a process of using a crosslinking agent, a process of encapsulating in a polymer matrix, a process of covering with a dialysis membrane, and a process of using a photo-induced crosslinkable polymer, a conductive polymer or a redox-type polymer. Each of the processes can be used alone or in combination.

According to the present invention, a sensor used for fructosamine assay can be constructed as follows.

In an amperometric assay system using a carbon, gold or platinum electrode, a general base catalyst may be immobilized on a working electrode. The working electrode, a counter electrode (e.g., a platinum electrode) and a reference electrode (e.g., Ag/AgCl electrode) are placed in a buffer containing a mediator, and the buffer is held at a constant temperature. A sample to be assayed is added to the buffer while a predetermined voltage is applied to the working electrode, and a current increase is monitored. Examples of the mediator include, for example, potassium ferricyanide, ferrocene, osmium derivatives and phenazine methosulfate. Such a mediator may also be impregnated into a polymer. The mediator may be added to and mixed with the polymer upon the polymerization reaction. Copolymers containing a mediator, for example, a copolymer of vinylferrocene and vinylimidazole, may also be used.

An amperometric system using a carbon, gold or platinum electrode may employ a electron mediator immobilized on the electrode. In this system, a general base catalyst and an electron mediator can be immobilized on a polymer matrix on the working electrode by adsorption or through a covalent bond. The working electrode, a counter electrode (e.g., a platinum electrode) and a reference electrode (e.g., Ag/AgCl electrode) are placed in a buffer, and the buffer is held at a constant temperature. A sample to be assayed is added to the buffer while a predetermined voltage is applied to the working electrode, and the current is monitored. Examples of the electron mediator includes potassium ferricyanide, ferrocene, osmium derivatives and phenazine methosulfate.

A carbon paste electrode is commercially available from Bioanalytical Systems Inc. (BAS) (IN, USA). A carbon electrode can be constructed by filling carbon paste available from BAS into a concave of an electrode available from BAS. In this procedure, an imidazole catalyst such as polyvinyl imidazole for use in the present invention may be kneaded with the carbon paste and filled into the concave of the electrode.

The fructosyl-valine concentration in the sample can be determined based on a calibration curve prepared by using standard fructosyl-valine solutions.

For the HbA1c assay sensor, a proteolytic enzyme (e.g., a protease) immobilized on a membrane may be combined with the fructosyl-valine assay sensor described above to obtain a composite sensor. The structure of such a composite sensor employing a combination of serial reactions by plural enzymes is well known in the art and are described in, for example, Biosensors—Fundamental and Applications—Anthony P. F. Tuner, Isao Karube and Geroge S. Wilson, Oxford University Press 1987.

For the glycated albumin assay sensor, a proteolytic enzyme (e.g., a protease) immobilized on a membrane may be combined with the fructosyl-ε-lysine assay sensor to obtain a composite sensor.

The sensors for HbA1 c assay and for glycated albumin assay of the present invention are useful for diagnosis of diabetes mellitus.

The present invention will be illustrated in further detail with reference to the examples below, which are not intended to limit the scope of the invention.

### EXAMPLE 1

To 30 mmol of 1-vinylimidazole was added 0.6 mmol of 2,2′-Azobis(2,4-dimethylvaleronitrile) as a polymerization initiator, and allowed for a polymerization reaction under argon gas at 45° C. for 24 hours. The resulting polymer was ground in a mortar and sieved to give a polymer having a particle size of 40 μm.

### EXAMPLE 2

Fructosyl-valine as a substrate was added to 10 mM potassium phosphate buffer (pH 7.0) in the presence of 10 mg of the polymer obtained in Example 1, 2 mM PMS and 0.06 mM DCIP. Decrease in absorbance of DCIP was monitored at 600 nm. The result is shown in FIG. 1. By using this method, fructosyl-valine can be assayed in the range of from 0.5 to 20 mM.

### EXAMPLE 3

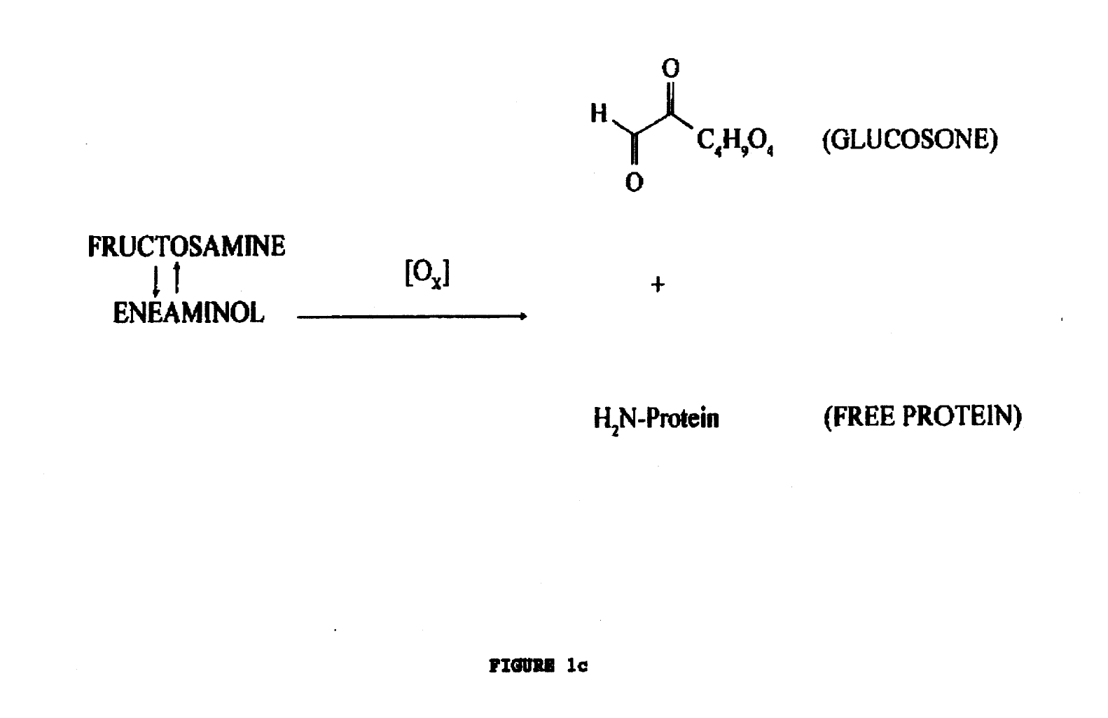

10 mM of fructosyl-valine as a substrate was added to 10 mM potassium phosphate buffer solution (pH 7.0) in the presence of 1-vinylimidazole in different concentrations as a catalyst, 2 mM PMS and 0.06 mM DCIP. Decrease in absorbance of DCIP was monitored at 600 nm. The result is shown in FIG. 2. It was shown that the reaction rate increases with an increasing amount of 1-vinylimidazole, and that 1-vinylimidazole can serve as a catalyst for oxidation of fructosyl-valine.

### EXAMPLE 4

1-Vinylimidazole was mixed with EGDMA as a crosslinking agent in a ratio of 1:1, 1:3, or 1:5 (the amounts of 1-vinylimidazole and EGDMA were 2 mmol: 2 mmol, 1 mmol:3 mmol, or 1 mmol:5 mmol). -A polymerization initiator 2,2′-Azobis(2,4-dimethylvaleronitrile) (0.12 mmol, 0.14 mmol, or 0.22 mmol) were added to the mixture. The resulting mixture was dissolved in methanol, and allowed for polymerization reaction under argon gas at 45° C. for 12 hours. The resulting polymer was ground in a mortar and sieved to give a polymer having a particle size of 60 μm.

### EXAMPLE 5

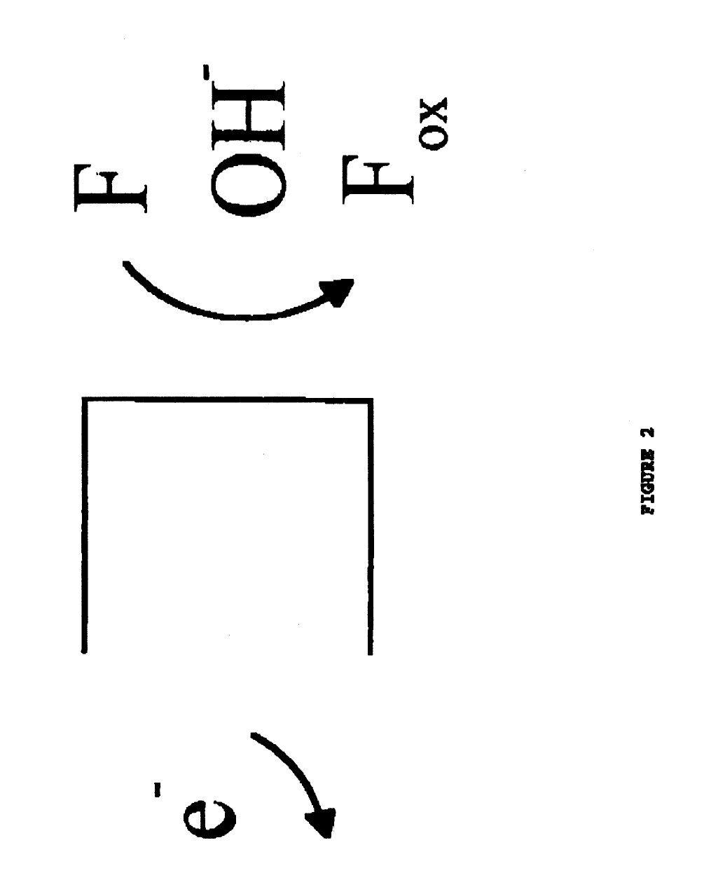

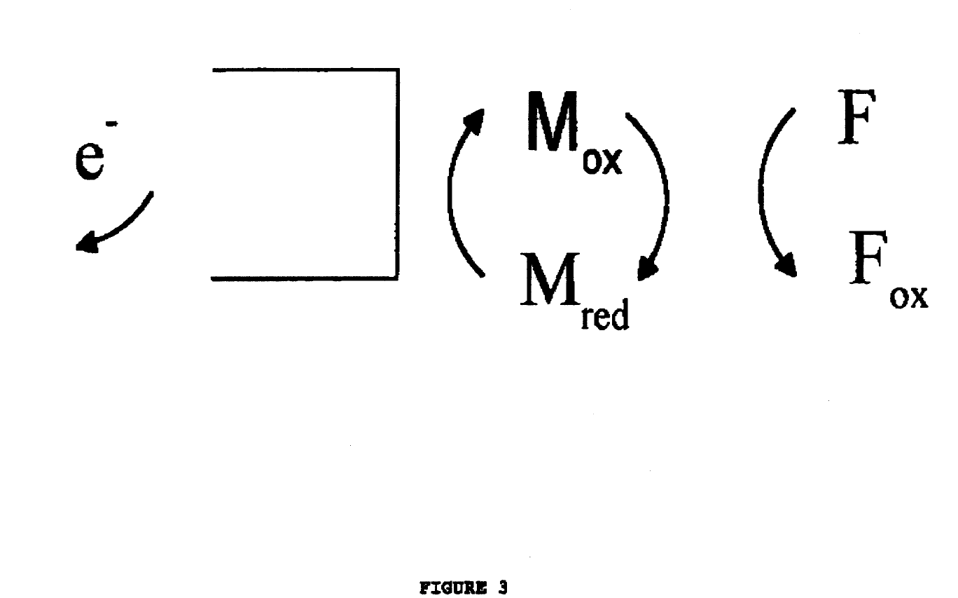

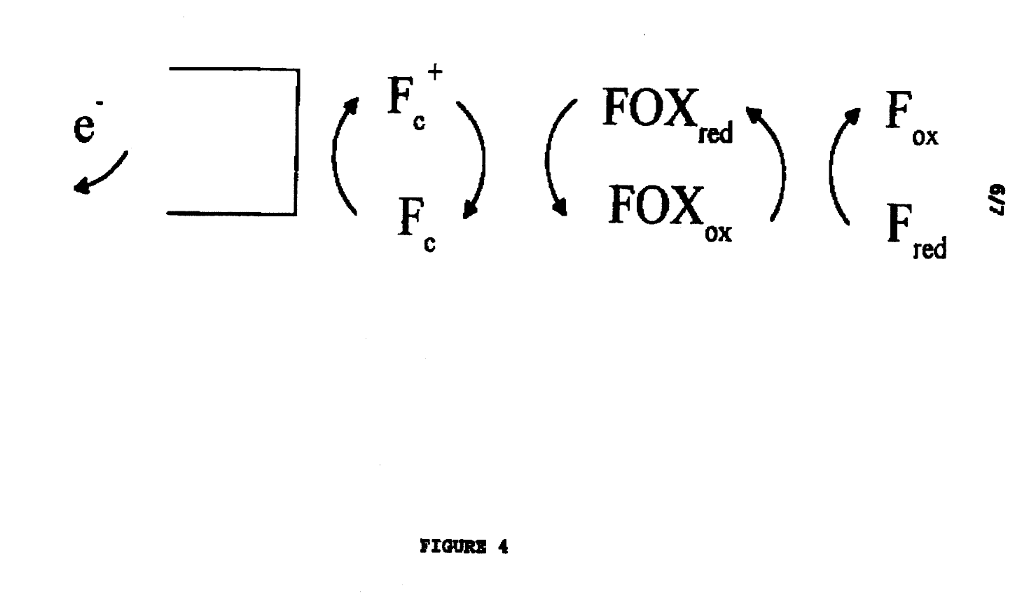

To 50 mg of carbon paste was added 20 mg of the polymer prepared in Example 1, and the resulting mixture was filled in a carbon paste electrode. The electrode was placed in a solution of 10 mM phosphate buffer saline (pH 7.4) containing 1 mM 1-methoxyphenazine methosulfate (m-PMS). Fructosyl-valine as a substrate was added to the solution while voltage of 100 mV (vs. Ag/AgCl) was applied, and the response of the sensor was monitored (FIG. 3). Also Fructosyl-valine was assayed by using the sensor (FIG. 4).

### EXAMPLE 6

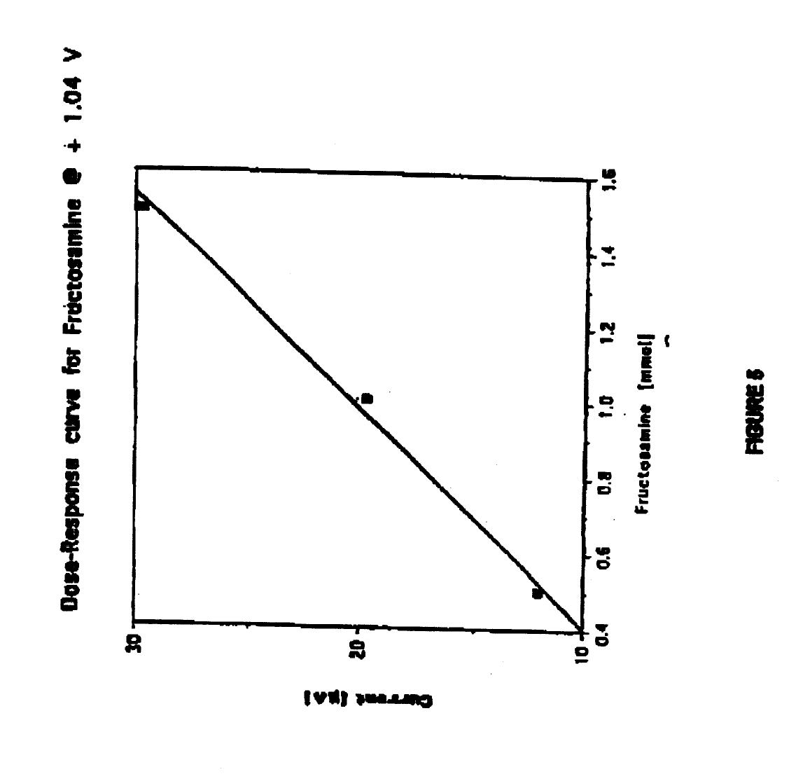

To 50 mg of carbon paste was added 20 mg of the polymer prepared in Example 3, and the resulting mixture was filled in a carbon paste electrode. The electrode was placed in a solution of 10 mM phosphate buffer saline (pH 7.4) containing 1 mM m-PMS. Fructosyl-valine as a substrate was added to the solution while voltage of 100 mV (vs. Ag/AgCl) was applied, and the response was monitored. Fructosyl-valine was assayed by using the sensor as shown in FIG. 5, indicating that fructosyl-valine can be assayed at a level of 20 μM or less.

1. A method for assaying fructosamine comprising oxidizing fructosamine in the presence of an appropriate mediator (electron acceptor) and an imidazole containing compound as a catalyst, and measuring the amount of the reduced mediator.

2. A method for assaying fructosamine in a sample comprising the steps of:
1) reacting the sample in a reaction solution at pH 6-10 with an imidazole containing compound in the presence of a mediator;
2) measuring the amount of a reduced mediator formed by the reaction; and
3) determining the concentration of the fructosamine in the sample based on a calibration curve prepared by using standard fructosamine solutions.

3. A method for assaying a glycated protein in a sample comprising the steps of:
1) enzymatically or chemically degrading the glycated protein in the sample to form fructosamine;
2) reacting the sample in a reaction solution at pH 6-10 with an imidazole containing compound in the presence of a mediator;
3) measuring the amount of a reduced mediator formed by the reaction;
4) determining the concentration of the fructosamine based on a calibration curve prepared by using standard fructosamine solutions; and
5) determining the amount of the glycated protein in the sample based on the concentration of the fructosamine.

4. The method according to any one of claims 1 to 3 wherein the imidazole-containing compound is a polymer of vinylimidazole.

5. The method according to any one of claims 1 to 3 wherein the amount of the reduced mediator formed by the reaction between fructosamine and the imidazole containing compound is measured by spectroscopy.

6. The method according to any one of claims 1 to 3 wherein the amount of the reduced mediator formed by the reaction between the fructosamine and the imidazole containing compound is measured electrochemically.

7. The method according to claim 3 wherein the glycated protein is glycated hemoglobin or glycated albumin.

8. A fructosamine assay kit comprising an imidazole containing compound, which may optionally comprise at least one selected from a buffer solution, a mediator, a standard solution of a fructosamine or its derivative for the preparation of a calibration curve, and a direction for use.

9. A sensor for fructosamine assay, comprising a working electrode on which an imidazole containing compound is immobilized, a counter electrode, and a reference electrode in a buffer solution.

10. The sensor for fructosamine assay according to claim 9 wherein the buffer solution comprises a mediator.

11. The sensor for fructosamine assay according to claim 9 or 10 wherein the electrode comprises carbon paste.

12. A glycated hemoglobin assay kit comprising an imidazole containing compound, which may optionally comprise at least one selected from a hydrolytic reagent or proteolytic enzyme capable of acting on glycated hemoglobin, a buffer solution, a mediator, a standard solution of fructosyl-valine or its derivative for the preparation of a calibration curve, and a direction for use.

13. A sensor for glycated hemoglobin assay comprising a working electrode on which an imidazole containing compound is immobilized, a counter electrode, and a reference electrode in a buffer solution.

14. A glycated albumin assay kit comprising an imidazole containing compound, which may optionally comprise at least one selected from a hydrolytic reagent or proteolytic enzyme capable of acting on glycated albumin, a buffer solution, a mediator, a standard solution of fructosyl-E-lysine or its derivative for the preparation of a calibration curve, and a direction for use.

15. A sensor for glycated albumin assay comprising a working electrode on which an imidazole containing compound is immobilized, a counter electrode, and a reference electrode in a buffer solution.

16. A method for diagnosis of diabetes mellitus comprising the step of measuring fructosamine or a glycated protein in a sample from a subject using the method as claimed in any one of claims 1 to 3.
